(19) United States
(12) Patent Application Publication
(10) Pub. No.: US 2026/0291942 A1
(43) Pub. Date: Sep. 24, 2026

(54) SECURITY CONTROL ENGINE(S) FOR DYNAMICALLY CONTROLLING REMOTE ACCESS TO PRIVILEGED AUTHENTICATION SYSTEMS

(71) Applicant: Microsoft Technology Licensing, LLC, Redmond, WA (US)

(72) Inventors: Shir FELDMAN, Tel Aviv (IL); Noa MANKET, Tel Aviv (IL); Yoav YASSOUR, Zikhron Yaakov (IL); Benyamin FARSHTEINDIKER, Petah Tiqwa (IL); Nir AVNERY, Tel Aviv (IL); Tomer TELLER, Tel Aviv (IL); Ali MUSTAFA, Berlin (DE); Shai YANNAI, Haifa (IL); Yarden LEVY, Tel Aviv (IL)

(21) Appl. No.: 19/085,213

(22) Filed: Mar. 20, 2025

(51) Int. Cl. H04L 9/40

(52) U.S. Cl. CPC H04L 63/104

(57) ABSTRACT

Systems and methods herein provide a security control engine and its related functions. In an aspect, a security control engine is provided for controlling access to one or more privileged authentication systems, such as a domain controller. To control remote access to the privileged authentication systems, the security control engine identifies which network devices correspond to the privileged authentication systems. The security control engine also retrieves historical data of client devices within the network and identifies a subset of the client devices as authorized for privileged authentication systems access based on the historical data. The security control engine then determines a remaining subset of client devices as unauthorized to remotely access the privileged authentication systems and blocks the respective client devices from remotely accessing the one or more network devices corresponding to the privileged authentication systems.

### TECHNICAL FIELD

Aspects of the disclosure are related to the field of computer software applications and services and, in particular, to security control engines for autonomously and dynamically controlling remote access to privileged authorization systems within a network, such as domain controllers.

### BACKGROUND

In the modern era, business and personal spaces are becoming increasingly digitized and dispersed. As such, remote desktop access is increasingly relied upon to enable administrators and users to manage critical systems from virtually anywhere. However, a significant downfall of remote desktop access is the attack surface it exposes to malicious actors. This risk is particularly concerning when remote desktop access is used to access privileged authentication systems, which are responsible for verifying user identities, enforcing security policies, and controlling access to sensitive network resources. Among privileged authentication systems, domain controllers play a central role in managing authentication and authorization within network domains, maintaining critical user, device, and permission data. When remote desktop access is exploited, privileged authentication systems become prime targets for attackers seeking to infiltrate networks, escalate privileges, and exfiltrate sensitive information. Vulnerabilities in remote access mechanisms can facilitate unauthorized access, malware deployment, and widespread compromise, making privileged authentication systems high-value targets in cyber threats.

### SUMMARY

Technology disclosed herein includes software applications and services that provide a security control engine, and its related functions. In an aspect, a security control engine determines client devices within a network for evaluation of privileged authentication system access, such as access to a domain controller. The security control engine then determines historical data for the client devices, such as retrieving outgoing network connections from a network log. Simultaneously or subsequently, the security control engine may also determine which network devices within the network correspond to domain controllers. To make this determination, the security control engine may retrieve authentication signals for the network devices and parse the authentication signals to identify network devices having patterns or characteristics of domain controllers.

Once the domain controllers are identified, the security control engine may classify the client devices into groups indicating domain controller access authorization. For example, the security control engine may identify subset of client devices as authorized to remotely access the domain controllers based on historical data and classify the subset of client devices into an authorized group. The security control engine may then identify the remaining subset of client devices and classify the remaining subset into an unauthorized group. The security control engine may then apply an access policy to the client devices based on their respective classification. For example, the security control engine may apply an access policy to the remaining subset of client devices in the unauthorized group that blocks remote access to one or more domain controllers.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a security control engine, according to an embodiment herein;

FIG. 2 illustrates an example environment in which a security control engine is leveraged for remotely accessing a privileged authorization system, according to an embodiment herein;

FIG. 3 illustrates a process for providing a security control engine and its related functions, according to an embodiment herein; and

FIG. 4 illustrates an example operational flow in which a security control engine dynamically adjusts domain controller, according to an embodiment herein; and

FIG. 5 shows an example client device suitable for providing a security control engine and related functions, according to an embodiment herein.

### DETAILED DESCRIPTION

Privileged authentication systems within a network, such as domain controllers and other core identity management systems represent a critical attack surface frequently targeted by malicious actors. These privileged authentication systems serve as the core of enterprise security, managing user authentication, enforcing access controls, and maintaining the integrity of sensitive data. Their privileged nature makes them a prime objective for attackers seeking to escalate privileges, establish persistent access, or disrupt operations. Exploiting weaknesses in access controls, misconfigurations, and exposed network services, malicious actors can manipulate privileged authentication systems to compromise entire environments. As organizations expand their reliance on interconnected systems and remote access capabilities, the attack surface continues to grow, offering adversaries more opportunities to infiltrate and exploit network infrastructure.

One common method attackers use to target privileged authentication systems is through the abuse of remote management services and protocols, such as Remote Desktop Protocol (RDP), Secure Shell (SSH), and Virtual Network Computing (VNC). By gaining unauthorized access—often through brute force attacks, stolen credentials, or phishing tactics—threat actors can establish remote connections to privileged authentication systems, such as domain controllers or Lightweight Directory Access Protocol (LDAP) servers. In documented ransomware operations, attackers have leveraged exposed RDP endpoints to move laterally within an organization's network, escalate privileges, and execute commands that disrupt business operations. By taking control of these critical authentication systems, malicious actors can create backdoor accounts, disable security mechanisms, and deploy malware at scale.

Conventional approaches to minimizing these attack surfaces, while effective in reducing risk, fail to fully address the underlying security threats posed by malicious actors gaining access to privileged authentication systems through remote management protocols. Common security measures such as multi-factor authentication (MFA), network segmentation, and strict access control policies are widely used to prevent unauthorized access to privileged authentication systems. However, these defenses remain vulnerable to tactics such as credential theft, session hijacking, and adversary-in-the-middle (AitM) attacks, which allow attackers to bypass authentication mechanisms. Even with MFA in place, stolen authentication tokens or social engineering techniques can enable an attacker to gain entry through legitimate remote access channels. Additionally, traditional perimeter-based defenses struggle to differentiate between an authorized user and a compromised device, especially when attackers exploit weaknesses in remote desktop solutions. This persistent challenge highlights a fundamental limitation in conventional security models: the difficulty of reliably authenticating not just a user's identity but also the legitimacy of the remote client device accessing a privileged authentication system like a domain controller. As long as attackers can exploit weaknesses in remote authentication and session management, critical network assets will remain exposed to compromise.

Securing access to privileged authentication systems, particularly remote access, is further complicated by the dynamic nature of access points to these critical systems. Unlike static infrastructure, where access points remain fixed, the access points to privileged authentication systems can change over time due to modifications in network architecture, system updates, or cloud-based deployments. As used herein, the term “dynamic” encompasses this shifting of access points, where the location or means of accessing a privileged authentication system is subject to variation rather than remaining constant. For example, in cloud-hosted environments, domain controllers may be assigned dynamic IP addresses by cloud service providers, making it difficult to enforce strict network access controls based on predefined IP whitelisting. Additionally, load-balancing mechanisms and failover configurations can redirect authentication requests to different instances of a privileged authentication system, such as a domain controller, further complicating the ability to track and secure access consistently. This on-going shifting in access points introduces gaps that attackers can exploit, such as leveraging misconfigured firewall rules, exploiting cached credentials, or intercepting traffic intended for a legitimate privileged authentication system. As a result, the challenge of securing remote access to privileged authentication systems is not only a matter of authenticating users and devices but also ensuring that security controls remain adaptive to the evolving network landscape.

The inability of conventional security approaches to address these complexities leaves privileged authentication systems vulnerable to exploitation, exposing organizations to severe consequences. The reliance on static security controls, traditional perimeter defenses, and authentication mechanisms such as multi-factor authentication fails to account for the dynamic nature of access points, creating gaps that attackers can leverage to gain unauthorized access. Remote management protocols, even when safeguarded with layered security controls, remain susceptible to credential theft, session hijacking, and adversary-in-the-middle attacks. Once attackers infiltrate privileged authentication systems, the impact can be devastating. For instance, compromised domain controllers provide unrestricted access to user credentials, allowing adversaries to impersonate legitimate users and move undetected through an organization's network. Business-critical operations can be disrupted, sensitive data can be exfiltrated, and entire infrastructures can be encrypted or destroyed for financial gain, espionage, or sabotage. Organizations often face operational paralysis, reputational harm, and legal consequences as a result of these breaches. The exposure of such attack surfaces remains a persistent risk, particularly as adversaries refine their techniques to bypass traditional security measures and exploit weaknesses in remote authentication frameworks. As long as security frameworks struggle to reliably authenticate and validate remote access in dynamic and distributed environments, privileged authentication systems will continue to be prime targets for malicious actors.

To address at least these shortcomings of conventional security frameworks, example security control engine(s) are provided herein. As described in greater detail below, the security control engine provided herein automatically and dynamically controls access of users and/or client devices to privileged authentication systems. For instance, the security control engine determines historical data of a client device to determine its outgoing network connections during a predefined time period. The security control engine then determines which network devices were privileged authentication systems during that predefined time period, and whether any of the outgoing network connections for the client devices were connected to a privileged authentication system. In an example embodiment, this may include comparing the IP addresses in the outgoing network connections to the IP addresses assigned to the network devices identified as privileged authentication systems. If the security control engine determines that the client device established a connection with the privileged authentication system during the predefined time period, the security control engine classifies the client device into an authorized group for remotely accessing one or more of the privileged authentication systems. In contrast, if the client device failed to establish a connection with a privileged authentication system during the predefined time period, then the security control engine may classify the client device into an unauthorized group for remotely accessing one or more of the privileged authentication systems. As will be expanded on below, the security control engine may generate and apply one or more access policies to the unauthorized group to restrict access to one or more privileged authentication systems.

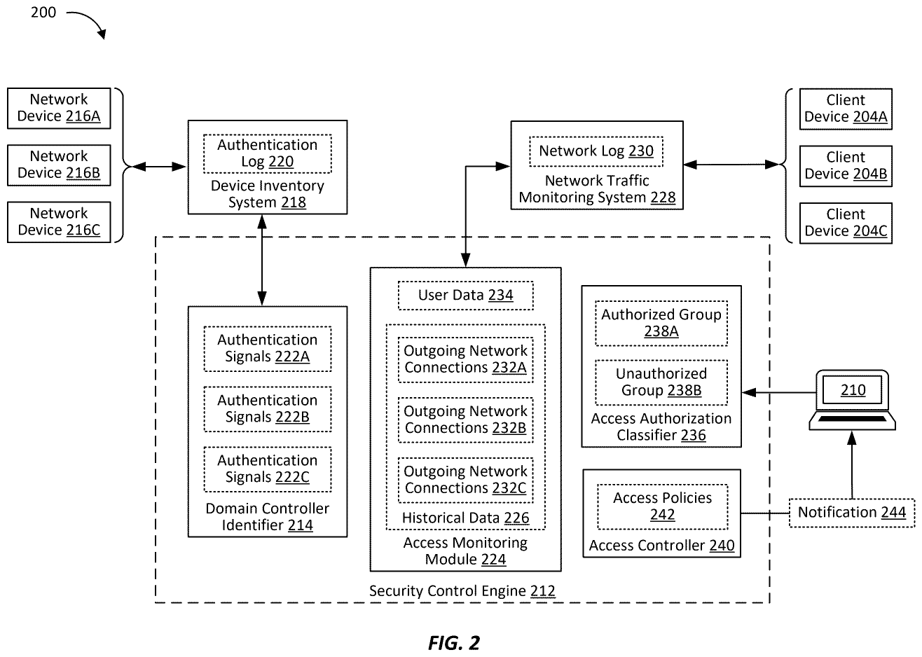

The security control engine may perform one or more of the above steps for multiple client devices within a given network in an iterative manner. That is, at predefined intervals, the security control engine may evaluate the historical data, and in some cases user data, associated with the client devices to determine whether any of the client devices established a connection with a privileged authentication system during a predefined time period. During each iteration, the security control engine determines which of the network devices corresponds to a privileged authentication system. As noted above, in modern network architectures, access points of privileged authentication systems may shift over time, and as such, the security control engine may determine the access point information for a respective privilege authentication system at each interval. This access point information is then used to determine whether a respective client device established a connection with a privileged authentication system within the predefined time period. Each of these steps are described in greater detail below with respect to FIGS. 2-4.

By iteratively evaluating and classifying client devices, and in some cases users, into authorized or unauthorized groups for remotely accessing privileged authentication systems, the security control engine delivers a higher level of network security than conventional security frameworks. Because the security control engine does not rely on static security controls, and instead dynamically identifies privilege authentication systems and adjusts classification of client devices (or users) based on the real-time environment of the network, the security control engine mitigates the vulnerabilities associated with stolen credentials and session hijacking. Additionally, the security control engine enhances resiliency against adversary-in-the-middle attacks by ensuring that authentication is not solely tied to user credentials but also to the integrity of a remote client device and the access pathway itself. With the ability to enforce access policies that adjust in real-time based on shifting network architectures and evolving attack tactics, the security control engine addresses the critical security gaps left by conventional security frameworks, thereby reducing the attack surface that malicious actors can exploit. Ultimately, the security control engine provides organizations with stronger assurance that remote access to privileged authentication systems is both secure and adaptive, without impeding operational efficiency or legitimate administrative access.

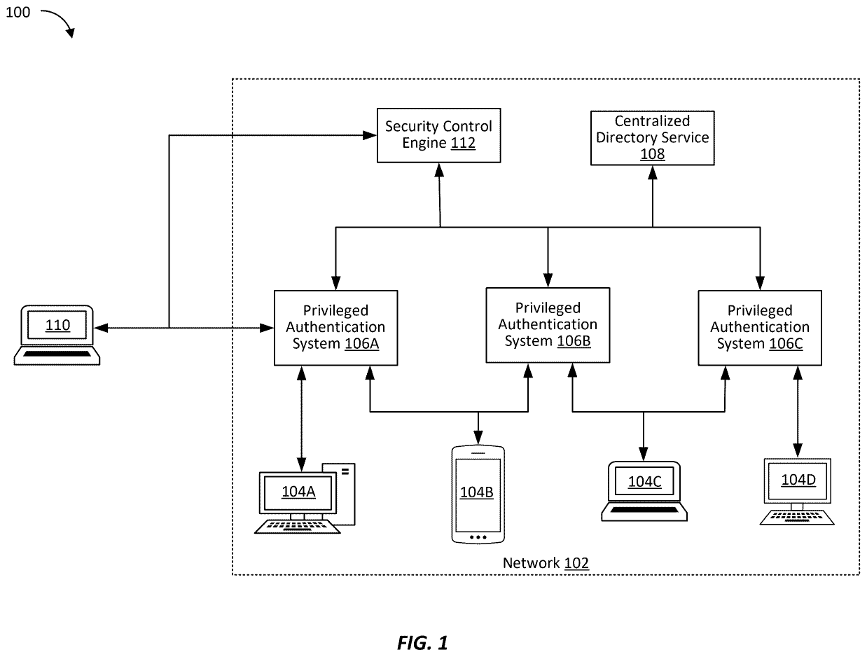

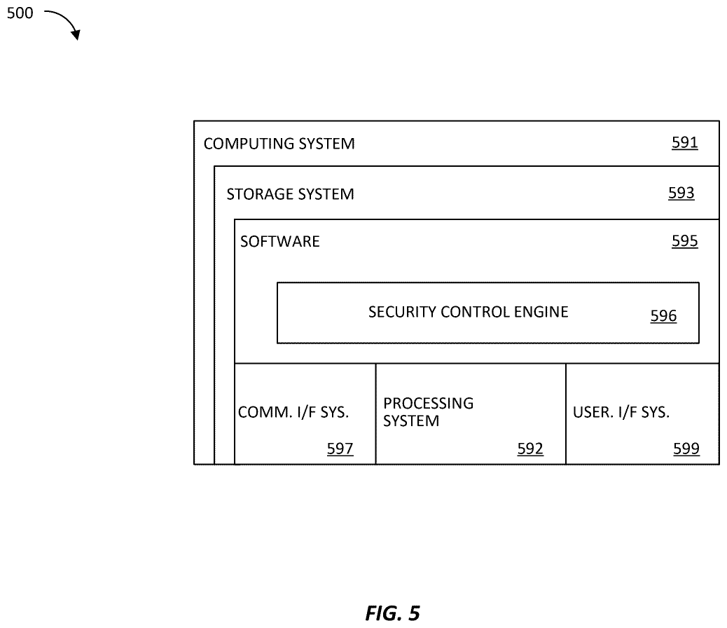

Turning now to the Figures, FIG. 1 illustrates an operational environment 100 for providing a security control engine 112, according to an embodiment herein. As shown, the operational environment 100 includes a network 102 containing client devices 104A-D. Broadly speaking, the client devices 104A-D may include a wide range of computing and communication devices such as personal computers, tablet computers, mobile phones, gaming consoles, wearable devices, Internet of Things (IoT) devices, and any other suitable network-enabled devices. The client devices 104A-C serve as endpoints within the network 102, facilitating user access to various resources and services. The system 500 in FIG. 5 is broadly representative of such client devices 104A-C, encompassing a range of hardware and software configurations tailored to different use cases.

The client devices 104A-D are in operable communication with other devices within the network 102, including direct interactions with one another, external client devices (not shown), and various network devices, such as privileged authentication systems 106A-D. Communication between the client devices 104A-D and the other devices within the network 102 may occur over wired or wireless connections, utilizing various networking protocols such as Ethernet, Wi-Fi, Bluetooth, cellular networks, or other suitable communication technologies. In some embodiments, the network 102 may encompass the Internet, intranets, wired and wireless networks, local area networks (LANs), wide area networks (WANs), virtual private networks (VPNs), software-defined networks (SDNs), or any combination thereof, facilitating connectivity between the client devices 104A-D and other components within the network 102. While only the client devices 104A-D and privileged authentication systems 106A-D are illustrated for simplicity, it should be understood that the network 102 may support any number of client devices 104A-D, privileged authentication systems 106A-C, and additional networked components, such as application servers, security appliances, network gateways, and cloud-based services.

The client devices 104A-D interact with the privileged authentication systems 106A-D to establish and verify user identities of the client devices 104A-D, enforce access controls, and facilitate secure authentication procedures. The privileged authentication systems 106A-D may be or include various types of authentication components, such as domain controllers, directory servers, identity providers, and other core authentication infrastructure responsible for managing credentials and user permissions. When the client devices 104A-D attempt to access a restricted resource within the network 102, the respective client device 104A-D may communicate with one or more of these privileged authentication systems 106A-C to validate credentials, retrieve authorization tokens, or establish a secure session. Depending on the network's 102 architecture, these authentication requests may be processed locally within the enterprise infrastructure or via cloud-based authentication services.

The privileged authentication systems 106A-C may be in operable communication with a centralized directory service 108, which may be or include an Active Directory (AD), Lightweight Directory Access Protocol (LDAP) servers, FreeIPA, Red Hat Directory Server, and other enterprise directory services. The centralized directory service 108 functions as a core identity management system, maintaining and enforcing authentication and authorization policies across the network 102. In this capacity, the privileged authentication systems 106A-C interact with the centralized directory service 108 to verify user credentials, manage access permissions, and enforce security policies for client devices 104A-D. When one of the client device 104A-D requests access to a resource within the network 102, the request is processed by one of the privileged authentication systems 106A-C, which then queries the centralized directory service 108 to authenticate the user and determine their access rights based on preconfigured security policies and group memberships. The centralized directory service 108 supports various authentication protocols, such as Kerberos, NTLM, and LDAP, facilitating single sign-on (SSO) capabilities, policy enforcement, and secure access across distributed network environments. Through this communication, access requests from client devices 104A-D are consistently validated and authorized in accordance with organizational security requirements within the network 102.

In some embodiments, a remote client device 110, which may be the same or similar to the client devices 104A-D, may request access to one or more devices within the network 102. The remote client device 110 may connect over the Internet, a virtual private network (VPN), or another secure communication channel to establish a remote session with devices within the network 102. The term “remote,” as used herein, refers to the remote client device's 110 ability to initiate and maintain a remote session with devices within the network 102. For example, the remote client device 110 may utilize a remote access protocol, such as RDP, SSH, or VNC, to establish a connection with a privileged authentication system 106A. This remote access capability allows administrators and authorized users to manage authentication, perform administrative tasks, and access restricted resources from offsite locations. However, such remote access mechanisms introduce significant security challenges, as unauthorized entities may exploit exposed remote access services to gain illicit control over the privileged authentication systems 106A-C. As such, conventional security frameworks often enforce authentication and authorization processes for remote access requests from the remote client device 110, typically relying on multi-factor authentication (MFA), firewall control policies, and network security protocols to mitigate unauthorized access risks. As used herein, “remote access” refers to using a remote access protocol to establish a connection with an endpoint (e.g., a privileged authentication system 106A-C).

Despite these security measures, conventional authentication and authorization processes frequently fail to prevent malicious actors from gaining unauthorized access to the privileged authentication systems 106A-C. If the remote client device 110 is operated by a malicious actor, they may use stolen credentials, brute force attacks, or session hijacking techniques to exploit RDP, SSH, or other remote access protocols and impersonate a legitimate user. Traditional security frameworks often fail to detect such threats because they rely on static authentication mechanisms that validate user credentials but do not verify the legitimacy of the remote client device 110 itself. For example, even with MFA in place, an attacker who has obtained valid login credentials and an authentication token may be able to bypass authentication controls and establish a session indistinguishable from a legitimate one.

Furthermore, traditional security models struggle to differentiate between a trusted user accessing the privileged authentication system 106A-C remotely and a compromised session initiated from an unauthorized device, especially when perimeter defenses rely solely on IP whitelisting, VPN access, or credential-based authentication. Without a mechanism to dynamically assess device trustworthiness, user behavior, or session context, the privileged authentication systems 106A-C remain vulnerable to unauthorized access, allowing malicious actors to escalate privileges, create persistent backdoors, and compromise the broader network infrastructure undetected.

To address the vulnerabilities left under conventional security frameworks, the network 102 leverages a security control engine 112. As will be described in greater detail below with respect to FIGS. 2-4, the security control engine 112 may automatically and dynamically monitor the client devices 104A-D within the network 102 and remote client devices 110 that attempt to remotely access resources within the network 102. As used herein, “dynamically” refers to the security control engine's 112 iterative approach to classifying these client devices 1104A-D, 110 into a respective authorization group for remotely accessing one or more of the privileged authentication systems 106A-C based on the real-time environment of the network 102. In other words, “dynamically” means that the functions of the security control engine 112 account for the real-time environment of the network 102, a feature that conventional or manual security frameworks are unable to attain due to their reliance on static, predefined security policies that lack the capability to continuously adapt to shifting access points, evolving threat landscapes, and contextual risk factors, such as the historical data of the client devices 104A-D, 110, in real time. This distinction underscores a fundamental technical improvement over existing security frameworks, as conventional systems operate based on fixed authentication rules and perimeter-based defenses, which do not incorporate continuous, automated analysis of network conditions and access behaviors.

In an example, at each evaluation iteration, the security control engine 112 determines which network devices correspond to privileged authentication systems 106A-C and then determines whether the historical data of a respective client device indicates past interaction with the privileged authentication systems 106A-C. As described above, access points of a respective privileged authentication system 106A-C may shift or change over time, and same with a given user's authentication or permission level for remotely accessing the privileged authentication system 106A-C. As such, the security control engine 112 is able to determine whether a respective client device 104A-D, 110 is authorized to remotely access the privileged authentication system 106A-C given the current network environment.

In some embodiments, the security control engine 112 may also evaluate user data associated with the client devices 104A-D, 110 to determine whether access to the privileged authentication system 106A-C is authorized. For example, the security control engine 112 may determine user information of a respective user of the client device 104B, such as job position, role, title, administrative permission, etc., and grant access to the privileged authentication system 106A-C based on this information. In some cases, the user information of a user may be used to authenticate access to the privileged authentication system 106A-C for another user. For example, the user of the client device 104C may assume the responsibilities of the user of the client device 104B in an emergency scenario. Despite the client device 104C having limited previous interaction or connection with the privileged authentication system 106B, the security control engine 112 may determine that the client device 104C is authorized to remotely access the privileged authentication system 106B based on the user information of the client device 104C being substantially similar to that of the client device 104B (e.g., same job role, permissions level).

The security control engine 112 may tailor the access to a respective privileged authentication system 106A-C to a particular region or geographical location. For example, each of the privileged authentication systems 106A-C may be located in geographically distinct regions or locations. Based on the historical data, and in some cases the user data, the security control engine 112 may determine that the client devices 104A-D, 110 are authorized to remotely access a specific privileged authentication system 106A-C but are unauthorized to remotely access another privileged authentication system 106A-C. For example, based on the geographical regions of the privileged authentication systems 106A-C, the security control engine 112 may determine that the client device 104A is authorized to remotely access the privileged authentication system 106A but is unauthorized to remotely access the privileged authentication systems 106B-C. In other embodiments, even if the historical data indicates that the client device 104B only has outgoing network connections to the privileged authentication system 106A, the security control engine 112 may determine that the client device 104B is authorized to remotely access both the privileged authentication system 106A and 106B based on the user data (e.g., permission level, job role).

By tailoring access authorization for the client devices 104A-D, 110 in view of the real-world environment of the network 102, the security control engine 112 provides an additional layer of security beyond conventional security frameworks. The security control engine 112 enhances security by granting access to one or more of the privileged authentication systems 106A-C based on prior authorized access, user data, and/or geographic region. In some cases, the security control engine 112 may augment existing security approaches by classifying the client devices 104A-D, 110 into authorization groups while still requiring subsequent verification and authentication before granting access to the privileged authentication systems 106A-C. For example, even if the client device 104A is classified within an authorized group for remotely accessing the privileged authentication systems 106A-C, the security control engine 112 may still enforce multi-factor authentication (MFA) or other additional authentication measures before granting access. This layered approach ensures that authorization alone is not the sole criterion for access, adding an additional security checkpoint to mitigate unauthorized access risks.

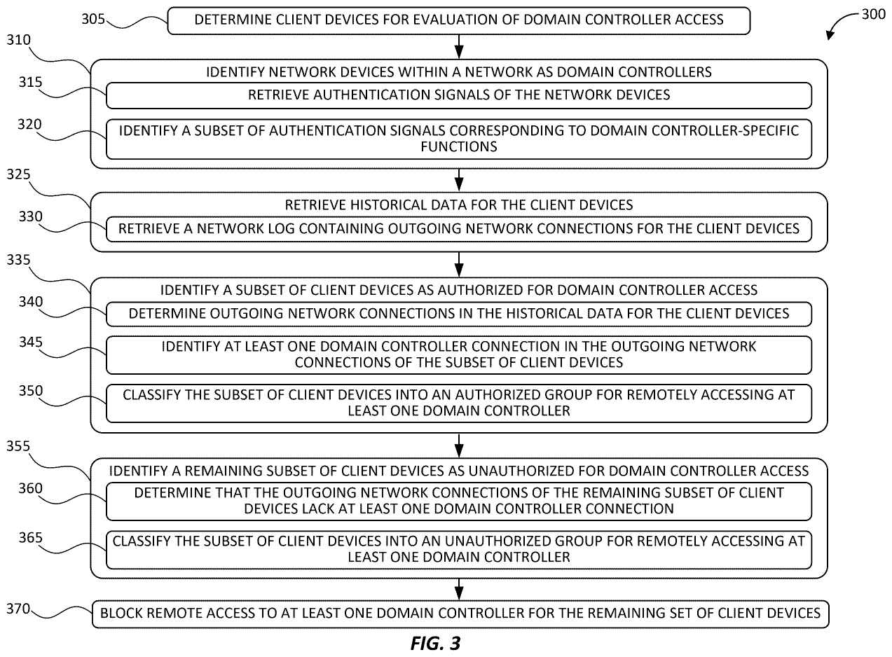

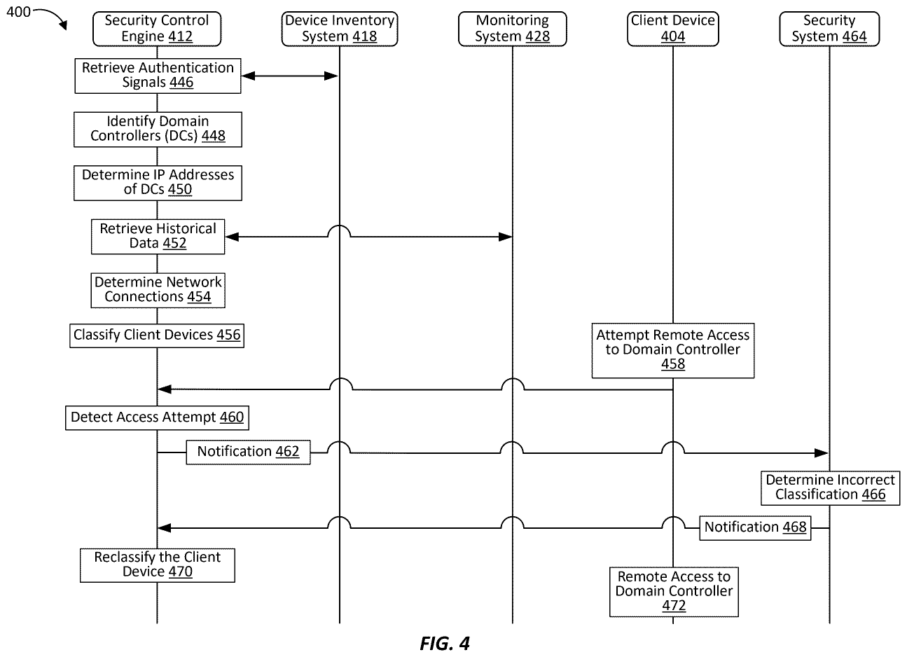

Referring now to FIG. 2, an example environment 200 in which a security control engine 212 is leveraged for controlling access to a privileged authorization system is illustrated, according to an embodiment herein. For ease of explanation, FIG. 2 is described with reference to FIG. 3, which illustrates a process 300 for providing a security control engine and one or more of its functions, according to an embodiment herein. While FIG. 3 is described in relation to FIG. 2, it should be appreciated that the process 300 is equally applicable to the remaining figures and components therein. FIG. 2 is also described with reference to FIGS. 4-6, each of which is referenced in turn in the following description.

The security control engine 212 is part of a network, such as the network 102, containing multiple network devices 216A-C. The network devices 216A-C may correspond to various components within the network, including one or more privileged authentication systems, such as the privileged authentication systems 106A-C. In the following description, the security control engine 212 is leveraged to control access to one or more domain controllers present within the network devices 216A-C. It should be appreciated, that while the following illustrative example is with respect to domain controllers, the description is equally applicable to other types of privileged authentication systems, such as directory servers or platforms, OpenLDAP, and the like. Additionally, while only three network devices 216A-C are illustrated, the security control engine 212 may monitor and evaluate any number of network devices 216A-C.

Since the network devices 216A-C contain one or more domain controllers, the security control engine 212 is leveraged to ensure that access is to these domain controllers is granted only for authorized client devices. As such, the security control engine 212 may determine client devices 204A-C for evaluation of privileged authentication system access, here domain controller access (305). In some cases, this may involve identifying the client devices 204A-C within or associated with the network 102. That is, the client devices 204A-C may be the same or similar to the client devices 104A-D and be part of the network in which the security control engine 212 is leveraged. As will be described in greater detail below, the security control engine 212 may evaluate the client devices 204A-C and their respective authorization classifications at various evaluation intervals (e.g., predefined time periods). For example, the security control engine 212 may perform one or more of the following steps at predefined time intervals (e.g., every 5 minutes, 10 minutes, hourly, or daily) to dynamically adjust access permissions to the domain controllers to the real-time environment of the network.

In addition to identifying the client devices 204A-C for evaluation, the security control engine 212 may determine the network devices 216A-C. Specifically, the security control engine 212 may identify which of the network devices 216A-C within the network are domain controllers (310). To determine which of the network devices 216A-C correspond to domain controllers, the security control engine 212 retrieves authentication signals of the network devices 216A-C. As described above, the access points of privileged authentication systems may shift over time, and as such, the security control engine 212 may identify which of the network devices 216A-C corresponds to a domain controller periodically or at a predefined time interval.

As illustrated, the security control engine 212 may include a domain controller identifier 214 that identifies which of the network devices 216A-C are functioning as domain controllers by analyzing authentication signals 222A-C associated with network devices 216A-C. In particular, the domain controller identifier 214 may retrieve these authentication signals 222A-C from a device inventory system 218. The device inventory system 218 may be a centralized repository that maintains records of network-connected devices and their attributes. As such, the device inventory system 218 collects and logs network traffic data, including authentication requests and responses, in an authentication log 220. The authentication log 220 may store key authentication parameters such as source and destination IP addresses, authentication protocols (e.g., Kerberos, NTLM, LDAP), timestamps, and authentication outcomes.

Responsive to retrieving the authentication signals 222A-C, the domain controller identifier 214 analyzes the authentication signals 222A-C to determine which network devices 216A-C are functioning as domain controllers. For example, the domain controller identifier 214 evaluates the authentication signals 222A-C to identify authentication patterns indicative of domain controller activity, such as frequent responses to authentication requests, issuance of authentication tokens (e.g., Kerberos tickets or NTLM challenges), processing of directory service queries (e.g., LDAP lookups), and handling authentication handshakes. The domain controller identifier 214 may also consider characteristics of the authentication signals 222A-C, such as authentication request volume, consistency of authentication responses, and interactions with directory services, such as the centralized directory service 108. Based on this analysis, the domain controller identifier 214 identifies a subset of authentication signals 222A-C that exhibit characteristics specific to domain controller operations (320). For instance, the domain controller identifier 214 identifies a subset of the authentication signals 222A-C, such as the authentication signals 222B-C, containing patterns indicative of domain controller functionality.

Once the domain controller identifier 214 identifies the subset of authentication signals 222B-C corresponding to one or more domain controllers, the domain controller identifier 214 determines which of the network devices 216A-C are associated with these authentication signals 222B-C. For example, the domain controller identifier 214 may analyze network traffic metadata, such as IP addresses, hostnames, and MAC addresses, to correlate the identified authentication signals with specific network devices. Based on this analysis, the domain controller identifier 214 determines that the network devices 216B-C are domain controllers, as their authentication signals 222B-C exhibit patterns and characteristics indicative of domain controller functionality, such as responding to authentication requests, issuing authentication tokens, and handling directory service queries.

It should be appreciated that while the domain controller identifier 214 is illustrated as part of the security control engine 212, in some embodiments, the domain controller identifier 214 may be an external system to the security control engine 212, such as hosted separately or by a third party. In such cases, the security control engine 212 may query the external system to determine which of the network devices 216A-C are domain controllers during a respective evaluation interval.

Following this determination, the security control engine 212 retrieves and analyzes the access point information of the identified domain controllers (i.e., network devices 216B-C). Access point information of the network devices 216B-C may include network identifiers such as IP addresses, subnet assignments, VLAN configurations, and port associations. Additionally, access point information may encompass device-specific attributes such as hostname, Active Directory site membership, authentication service roles, and geographic or logical network location. As will be described below, the access information of the identified domain controllers enables the security control engine 212 to manage enforce access controls for the client devices 204A-C and monitor authentication activities associated with domain controllers within the network.

The security control engine 212 also retrieves historical data for the client devices 204A-C (325) to facilitate the evaluation of domain controller access patterns. Specifically, the security control engine 212 includes an access monitoring module 224, which is responsible for collecting and analyzing historical data 226 related to the client devices 204A-C. As described below, the historical data 226 includes the outgoing network connections for the client devices 204A-C within the network. To retrieve the historical data 226, the access monitoring module 224 interfaces with a network traffic monitoring system 228. The network traffic monitoring system 228 maintains a comprehensive network log 230 that records access attempts, authentication requests, and other relevant network activities associated with the client devices 204A-C. By querying the network traffic monitoring system 228, the access monitoring module 224 can extract the historical data 226 associated with the client devices 204A-C.

From the historical data 226, the security control engine 212 identifies a subset of the client devices 204A-C, such as the client devices 204A-B, that are authorized for domain controller access (335). To determine which of the client devices 204A-C are authorized to remotely access one or more of the domain controllers, the security control engine 212 determines which of the client devices 204A-C have historical data containing a domain controller connection. That is, based on the historical data 226 of the client devices 204A-C, the security control engine 212 determines the outgoing network connections 232A-C for each of the client devices 204A-C (340).

From the outgoing network connections 232A-C, the security control engine 212 identifies one or more domain controller connections during the evaluation interval (345). A domain controller connection may be an outgoing network connection to an access point identified as corresponding to a domain controller. For example, the security control engine 212 may determine that the client device 204A contains an outgoing network connection to an IP address associated with the network device 216B, which is identified as a domain controller. Since the IP address of the outgoing network connection is to an identified domain controller, the security control engine 212 identifies this as a domain controller connection.

In other embodiments, a domain controller connection may be an outgoing network connection involving a remote management protocol. For example, a domain controller connection may be an outgoing network connection for a remote management session, such as an RDP session or a SSH session, to a network device 216B-C identified as a domain controller. In other words, the security control engine 212 may identify a domain controller connection as an outgoing network connection involving a remote management protocol to a network device 216B-C identified as a domain controller.

Once the security control engine 212 identifies a subset of client devices 204A-C, such as the client devices 204B-C, as containing one or more domain controller connections within their respective historical data 226, the security control engine 212 may classify the subset of client devices 204B-C into an authorized group for remotely accessing one or more domain controllers (350). In particular, the security control engine 212 may include an access authorization classifier 236 that classifies the subset of client devices 204B-C into an authorized group 238A.

The security control engine 212 may also identify a remaining subset of client devices 204A-C, such as the client device 204A, as unauthorized for domain controller access (355). In particular, the access authorization classifier 236 determines that the client device 204 C (e.g., the remaining subset of client devices) lacks at least one a domain controller connection in its respective outgoing network connections 222A (360). Based on a lack of domain controller connection within the predefined time period, the security control engine 212 may classify the client device 204A into an unauthorized group 238B for domain controller access (365). It should be appreciated that while the illustrated example only includes an authorized group 238A and an unauthorized group 238B, in other embodiments, there may be more than one authorized group 238A, or more than one unauthorized group 238B. For example, there may be multiple authorized groups 238A, each having a different tier of access permissions or scope of access, such as one authorized group 238A granting access to all domain controllers within the network, while a second authorized group 238A grants access to a limited number of domain controllers.

As noted above, in some embodiments, the access authorization classifier 236 may determine access authorization for the client devices 204A-C based on additional information associated with a respective client device. For example, in some embodiments, the access monitoring module 224 may determine user data 234 associated with the client devices 204A-C. The user data 234 may include various user information of a respective user, such as job role, permission level, department affiliation, authentication credentials, security clearance, and the like. The access monitoring module 224 may retrieve the user data 234 from an enterprise directory, such as the centralized directory service 108, and analyze the user data 234 in view of the historical data 226 for the client devices 204A-C. In some cases, even if a respective client device's 204A-C outgoing network connections 232A-C lack any domain controller connections, the security control engine 212 may still determine the client device 204A-C is authorized to remotely access a domain controller based on the user data 234.

In an example embodiment, the security control engine 212 may determine that the client device 204A is authorized to remotely access a domain controller, and thus be classified into the authorized group 238A, based on the user data 234 associated despite the outgoing network connections 232A associated with the client device 204A lacking a domain controller connection. That is, even if the outgoing network connections 232A of the client device 204A do not include an IP address to the network devices 216A-B identified as domain controllers during the evaluation interval, the security control engine 212 may determine that the client device 204A is authorized to remotely access the domain controllers based on the user data 234. This evaluation may include comparing the user data 234 of the client device 204A to the user data 234 associated with the client devices 204A-C. For instance, the access authorization classifier 236 may initially identify which of the client devices 204A-C are authorized for remote access based on the historical data 226 and then compare the user data 234 of the client devices 204B-C classified as authorized to the user data 234 of the client device 204A (e.g., the remaining subset of client devices) to determine if access authorization is still warranted despite a lack of a domain controller connection.

When determining access authorization for the client devices 204A-C, the access authorization classifier 236 may determine which of the domain controllers (e.g., identified network devices 216A-C) a respective client device is authorized to remotely access. In some embodiments, access authorization may function as a binary decision, where a client device 204A-C is either authorized or unauthorized to remotely access the domain controllers. In other embodiments, the security control engine 212 may determine not only whether a client device 204A-C is authorized to remotely access any domain controller but also specify which particular domain controller(s) the client device 204A-C is permitted to remotely access.

For instance, when the security control engine 212 identifies a domain controller connection in the outgoing network connections 222B associated with the client device 204B, the security control engine 212 may determine the geographic or network region of the associated domain controller. That is, based on the domain controller connection, the security control engine 212 identifies the geographic region of the corresponding network device 216A-C, and based on this geographic region, specify the domain controllers that the client device 204B is authorized to remotely access. For example, if the domain controller connection is to the network device 216A and the network device 216A is within a first geographic region, then security control engine 212 may identify whether there are any other domain controllers (e.g., network devices 216B-C) in the first geographic region. If there are other domain controllers in the first geographic region, such as the network device 216B, then the security control engine 212 may determine that the client device 204A is also authorized to remotely access that domain controller. However, since the network device 216C is in a second geographic region, the security control engine 212 may determine that the client device 204A is not authorized to remotely access that domain controller.

Once the security control engine 212 classifies the client devices 204A-C into the authorized group 238A and unauthorized group 238B, the security control engine 212 may block or otherwise restrict remote domain controller access to the remaining subset of client devices classified in the unauthorized group 238B (370). In particular, the security control engine 212 may include an access controller 240 that generates one or more access policies 242 and applies the access policies 242 to the unauthorized group 238B. In some cases, depending on the number and format of the authorized/unauthorized groups 238A-B, the access controller 240 may apply one or more of the access policies 242 to the client devices 204A-C in the authorized group 238A. For example, if a first authorized group 238A contains client devices 204A-C that are authorized to only remotely access a specific domain controller, and thus unauthorized to remotely access other domain controllers in the network, the access controller 240 may apply an access policy 242 to the first authorized group 238A, thereby blocking remote access to the other domain controllers in the network.

The access policy 242, when enforced on respective client devices 204A-C, may be configured to block or restrict the client devices' 204A-C ability to remotely access specific network devices 216A-C that are identified as domain controllers. For example, the access policy 242 may deny network traffic to a designated IP address or subnet associated with a domain controller (e.g., network device 216A) for a specific client device 204A using a remote access protocol (e.g., a RDP protocol). This enforcement can be implemented through various network security mechanisms, such as host-based firewalls (e.g., Windows Defender Firewall, iptables), endpoint protection solutions, or Group Policy Objects (GPOs) in an Active Directory environment.

In the above scenario, the access policy 242 is applied locally on the client devices 204A-C, making it a client-side security control. Implementing the restriction at the endpoint level (e.g., client-side) provides an additional layer of security, ensuring that even if a central network access control mechanism fails, individual client devices 204A-C still enforce domain controller access restrictions. Furthermore, client-side enforcement can enhance security monitoring capabilities. If a malicious actor attempts to establish a connection using a remote access protocol to a restricted domain controller from a compromised client device 204A, the security control engine 212 can detect and log the unauthorized connection attempt. This visibility allows for quicker incident response and mitigation of potential threats, such as lateral movement attacks or unauthorized privilege escalation within the network.

In some scenarios, however, it may be preferable to apply the access policy 242 on the network devices 216A-C (e.g., server-side) rather than on the client devices 204A-C. Server-side enforcement can be achieved through mechanisms such as network access control lists (ACLs), firewall rules, intrusion prevention systems (IPS), or authentication policies within the domain controller itself. By configuring these restrictions at the network device level, unauthorized connection attempts from restricted client devices 204A can be blocked before they reach the domain controller, reducing the attack surface and mitigating potential security risks. Additionally, server-side enforcement ensures that access policies are uniformly applied across the network, eliminating the risk of misconfigured or bypassed client-side controls.

Applying the access policy 242 on the server side offers several security and administrative advantages. First, it provides centralized control, allowing IT administrators to enforce access restrictions across multiple client devices without relying on individual endpoint configurations. This reduces the risk of access policy 242 inconsistencies and ensures compliance with organizational security standards. Second, server-side enforcement enhances resilience against compromised endpoints—if the client device 204A is infected with malware or an attacker gains control over it, the access policy 242 remains intact at the domain controller level, preventing unauthorized remote access attempts. Third, applying the access policies 242 at the network device level may enable better logging, monitoring, and anomaly detection, as all blocked connection attempts can be centrally logged and analyzed for potential security threats. This centralized visibility improves threat detection capabilities and incident response, helping organizations proactively mitigate security risks in real time.

As described above, the security control engine 212 may iteratively evaluate the client devices 204A-C access to the domain controllers within the network at a predefined time interval. That is, after classifying the client devices 204A-C into one of the authorized group 238A or the unauthorized group 238B, and applying the access policies 242 respectively, at a first time, the security control engine 212 may reevaluate, classify the client devices 204A-C, and reapply the access policy 242 at a subsequent second time, then a subsequent third time, etc. As described above, since real-time workflows, networks, and organizational structures (e.g., users' roles, positions, permission levels) are dynamic, and thus constantly changing, by iteratively evaluating the client devices' 204A-C access authorization, the security control engine 212 can ensure access is tailored to the real-time environment. As can be appreciated, by tailoring domain controller access to the real-time environment, the security control engine 212 ensures minimal disruption to the enterprise and respective workflows.

After applying the access policies 242, if the security controller engine 212 detects a remote access attempt by a client device 204A-C classified in the unauthorized group 238B, the security controller engine 212 may generate a notification 244 regarding the attempted access. Specifically, the access controller 240 monitors remote access attempts from client devices 204A-C that are classified in the unauthorized group 238B. It should be noted that while the term “access attempts” is used in the context of the unauthorized group 238B, it also applies to client devices 204A-C that belong to a tailored or limited-access authorized group 238A. In such cases, where a client device 204A-C is permitted to remotely access only a specific set of domain controllers, an “access attempt” includes any attempt by that device to access domain controllers using a remote access protocol beyond those explicitly authorized.

Responsive to detecting an access attempt to a domain controller, the access controller 240 may flag the connection attempt and generate the notification 244. The notification 244 may be transmitted to a client device 210. The client device 210 may be a client device associated with a security team that monitors the network. In some embodiments, the notification 244 may also be transmitted to the client device 204A-C attempting the domain controller access. In cases where the access attempt was from a legitimate user having authorization to remotely access the requested domain controller, the attempting user may notify the security team monitoring the network to request access. For example, if the client device 204A was classified into the unauthorized group 238B, however the user is authorized to remotely access one or more domain controllers in the network, responsive to receiving the notification 244 the client device 210 may notify the security control engine 212 of the misclassification of the client device 204A. Responsive to being notified of the misclassification, the security control engine 212 may modify the classification of the client device 204A to the authorized group 238A and/or revise the access policies 242 to be less restrictive to a particular group of client devices 204A-C and/or group of domain controllers.

Referring now to FIG. 4, an example operational flow 400 illustrating a security control engine 412 dynamically adjusting domain controller access is illustrated, according to an embodiment herein. The security control engine 412, which may be the same or similar to the security control engine 212, may monitor a network and control remote access to one or more domain controllers within the network. For a respective evaluation interval, the security control engine 412 may retrieve authentication signals, such as the authentication signals 222A-C, from a device inventory system 418, which may be the same or similar to the device inventory system 218 (446). Responsive to retrieving the authentication signals, the security control engine 412 may identify the domain controllers within the network (448). That is, based on the authentication signals, the security control engine 412 determines which network devices within the network correspond to domain controllers. As noted above, in some embodiments, the security control engine 412 may determine which network devices correspond to domain controllers by querying an external system. Once the domain controllers are identified, the security control engine 412 determines the IP addresses for the domain controllers (450).

Simultaneously or sequentially, the security control engine 412 retrieve historical data for client devices within the network, such as the historical data 226 for the client devices 204A-C (452). Responsive to retrieving the historical data 226, the security control engine 412 parses the historical data 226 to determine the network connections of the client devices. Specifically, the security control engine 412 parses the historical data 226 to determine the IP addresses of the outgoing network connections of the client devices. The IP addresses from the historical data 226 may be compared to the IP addresses of the identified domain controllers to see if any of the network connections are domain controller connections. Specifically, the security control engine 412 determines whether the IP address from the historical data 226 match the IP addresses of the identified domain controllers. The security control engine 412 also parses the historical data 226 to determine whether the network connections to the domain controllers involve a remote access protocol. In some embodiments, the security control engine 412 determines the domain controller connections as outgoing network connections involving remote access protocols to domain controllers, as identified by their IP addresses.

If the security control engine 412 identifies a domain controller connection (e.g., a connection involving a remote access protocol) and/or matching IP address(es), the security control engine 412 determines the corresponding client device(s) and classifies the identified client devices as authorized to remotely access one or more domain controllers (456). The security control engine 412 may also classify the remaining subset of client devices as unauthorized to remotely access the domain controllers.

In the illustrated example, the client device 404, which may be the same or similar to the client devices 204A-C, may be classified by the security control engine 412 into an unauthorized group. As such, when the client device 404 attempts to remotely access a domain controller (458), the client device 404 is blocked from establishing a connection with the domain controller. When the client device 404 attempts to remotely access the domain controller, the security control engine 412 detects the access attempt (460) and generates a notification of the access attempt. The notification is then transmitted to a security system 464 (462). The security system 464 may be a client device, such as the client device 210, that is associated with a security team that monitors the network. Responsive to the notification, the security system 464 may determine that the client device 404 is misclassified (466) and return a notification to the security control engine 412 of the misclassification (468).

When the security control engine 412 receives the notification from the security system 464, the security control engine 412 reclassifies the client device 404 (470). Because the security control engine 412 reclassifies the client device 404 into an authorized group and the client device 404 is able to establish a connection with the domain controller and thereby obtaining remote access to the domain controller (472). This connection is then logged as a domain controller connection during this time period and may be captured during the next evaluation interval, meaning that in the subsequent evaluation interval the client device 404 is likely to be grouped into the authorized group for remotely accessing the domain controller.

Referring to FIG. 5, FIG. 5 illustrates a system 500 including a computing apparatus 591 that may be used for providing or interacting with a security control engine and related functions, as described herein. For example, the client devices 104A-C, 110, 204A-C, or 210 may be or include the computing apparatus 591, while in another example, any of the network devices 116A-C or 216A-C may be or include the computer apparatus 591. As illustrated, the computing apparatus 591 includes a processing system 592 that includes a microprocessor and other circuitry that retrieves and executes software 595 from storage system 593. The processing system 592 may be implemented within a single processing device but may also be distributed across multiple processing devices or sub-systems that cooperate in executing program instructions. Examples of the processing system 592 include general purpose central processing units, graphical processing units, application specific processors, and logic devices, as well as any other type of processing device, combinations, or variations thereof.

The storage system 593 may comprise any computer-readable storage media or medium readable by processing system 592 and capable of storing software 595. The storage system 593 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 593 may also include computer readable communication media over which at least some of the software 595 may be communicated internally or externally. The storage system 593 may be implemented as a single storage device but may also be implemented across multiple storage devices or sub-systems co-located or distributed relative to each other. The storage system 593 may comprise additional elements, such as a controller capable of communicating with the processing system 592 or possibly other systems.

The software 595 (including security control engine process 596) may be implemented in program instructions and among other functions may, when executed by the processing system 592, direct the processing system 592 to operate as described with respect to the various operational scenarios, sequences, and processes illustrated herein. For example, the software 595 may include program instructions for implementing a security control engine and related functions, such as the process 300 or the operational flow 400, as described herein. In some cases, the software 595 may cause one or more features of the security control engine process 596 to provide or display respective components to a user via a user interface system 599 inoperable communication with a client device, such as the notification 244 to the client device 210.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 595 may include additional processes, programs, or components, such as operating system software, virtualization software, or other application software. The software 595 may also comprise firmware or some other form of machine-readable processing instructions executable by the processing system 592.

In general, the software 595 may, when loaded into the processing system 592 and executed, transform a suitable apparatus, system, or device (of which computing apparatus 591 is representative) overall from a general-purpose computing system into a special-purpose computing system customized to generate features, functionality, and user experiences provided by the security control engine. Indeed, encoding the software 595 on the storage system 593 may transform the physical structure of the storage system 593. The specific transformation of the physical structure may depend on various factors in different implementations of this description. Examples of such factors may include, but are not limited to, the technology used to implement the storage media of the storage system 593 and whether the computer-storage media are characterized as primary or secondary storage, as well as other factors.

For example, if the computer readable storage media are implemented as semiconductor-based memory, the software 595 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 597 may include communication connections and devices that allow for communication with other computing systems (not shown) over communication networks (not shown). Examples of connections and devices that together allow for inter-system communication may include network interface cards, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing apparatus 591 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA), graphics processing units (GPUs), or neural processing units (NPUs) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), FPGAs, GPUs, NPUS, and state machines. Such processors may further comprise programmable electronic devices such as programmable logic controllers (PLCs), programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of which may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a security control engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

As used herein, the term “engine” refers to a computer-related entity, including but not limited to a component, module, or system. An engine may be implemented as software running on a general-purpose processor, hardware, firmware, or any combination thereof. For example, an engine can take the form of a process executing on a hardware processor, a hardware-based processor itself, an object, an executable, a thread of execution, a program, or even an entire computing device.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage media; a security control engine comprising processor-executable instructions stored on the computer-readable storage media; and a processor coupled to the computer-readable storage media and configured to execute the processor-executable instructions, wherein the processor-executable instructions, when executed by the processor, direct the computing apparatus, to at least: determine a plurality of client devices within a network; determine historical data for the plurality of client devices, wherein the historical data comprises outgoing network connections for the plurality of client devices within the network; classify a subset of client devices of the plurality of client devices into an unauthorized group for remotely accessing at least one domain controller using the historical data of the respective client devices; and apply an access policy to the subset of client devices based on the subset of client devices being classified in the unauthorized group, wherein the access policy blocks remote access to the at least one domain controller.

Example 2 is the computing apparatus of any previous or subsequent Example, wherein the processor-executable instructions to classify the subset of client devices into the unauthorized group for remotely accessing the domain controller using the historical data of the respective client devices, when executed by the processor, further direct the computing apparatus to: identify a plurality of IP addresses within the outgoing network connections for the subset of client devices during an evaluation interval; determine that none of the plurality of IP addresses correspond to an IP address of a domain controller within the evaluation interval; and classify the subset of client devices into the unauthorized group based on none of the outgoing network connections corresponding to a domain controller.

Example 3 is the computing apparatus of any previous or subsequent Example, wherein: the processor-executable instructions, when executed by the processor, further direct the computing apparatus to: identify IP addresses of the one or more network devices identified as the one or more domain controllers; and the processor-executable instructions to classify the subset of client devices into the unauthorized group for remotely accessing the at least one domain controller using the historical data of the respective client devices, when executed by the processor, further direct the computing apparatus to: identify a second subset of client devices comprising outgoing network connections to the IP addresses of the one or more network devices identified as the one or more domain controllers; classify the second subset of client devices of the plurality of client devices into an authorized group for remotely accessing the at least one domain controller; and classify the subset of client devices into the unauthorized group based on the second subset of client devices being classified into the authorized group.

Example 4 is the computing apparatus of any previous or subsequent Example, wherein the processor-executable instructions, when executed by the processor, further direct the computing apparatus to: receive an indication that classification of a first client device into the unauthorized group is incorrect; modify the access policy to the subset of client devices based on the indication; and reclassify the first client device into an authorized group based on the modification to the access policy, wherein the authorized group is granted access to the at least one domain controller.

Example 5 is the computing apparatus of any previous or subsequent Example, wherein: classification of the subset of client devices into the unauthorized group for remotely accessing the at least one domain controller is determined based on the historical data of the respective client devices during a first time period; and the processor-executable instructions, when executed by the processor, further direct the computing apparatus to: determine the historical data for the subset of client devices during a second time period, wherein the second time period is different than the first time period; determine that the outgoing network connections for a first client device of the subset of client devices during the second time period comprise a domain controller connection to at least one domain controller; and remove the first client device from the unauthorized group for remotely accessing the at least one domain controller.

Example 6 is the computing apparatus of any previous or subsequent Example, wherein the processor-executable instructions, when executed by the processor, further direct the computing apparatus to: detect, by the security control engine, a connection attempt to the at least one domain controller by a first client device within the subset of client devices; block, by the security control engine, access of the first client device to the at least one domain controller based on the access policy; and generate, by the security control engine, a notification that the first client device is blocked from remotely accessing the at least one domain controller.

Example 7 is a method comprising: determining, by a security control engine, a plurality of client devices for evaluation of domain controller access; identifying, by the security control engine, one or more network devices within a network as one or more domain controllers; retrieving, by the security control engine, historical data of the plurality of client devices; identifying, by the security control engine, a subset of client devices of the plurality of client devices as authorized for domain controller access using the historical data of the respective client devices; and blocking, by the security control engine, a remaining subset of client devices of the plurality of client devices from remotely accessing the one or more network devices corresponding to the one or more domain controllers based on the historical data of the respective client devices.

Example 8 is the method of any previous or subsequent Example, wherein identifying, by the security control engine, the subset of client devices of the plurality of client devices as authorized for domain controller access further comprises: determining, by the security control engine, outgoing network connections for the subset of client devices from the historical data of the respective client devices; identifying, by the security control engine, one or more domain controller connections in the outgoing network connections for the subset of client devices; and classifying, by the security control engine, the subset of client devices as authorized for domain controller access based on the one or more domain controller connections.

Example 9 is the method of any previous or subsequent Example, wherein identifying, by the security control engine, the subset of client devices of the plurality of client devices as authorized for domain controller access further comprises: identifying, by the security control engine, IP addresses of the one or more network devices corresponding to the one or more domain controllers within an evaluation interval; identifying, by the security control engine, a subset of IP addresses from the historical data associated with the subset of client devices that match the IP addresses of the one or more network devices corresponding to the one or more domain controllers within the evaluation interval; and classifying, by the security control engine, the subset of client devices as authorized for domain controller access based on the subset of IP addresses matching the IP addresses of the one or more network devices corresponding to the one or more domain controllers.

Example 10 is the method of any previous or subsequent Example, wherein the subset of client devices comprises a first client device; and wherein identifying, by the security control engine, the subset of client devices of the plurality of client devices as authorized for domain controller access further comprises: identifying, by the security control engine, a second client device having domain controller access; determining, by the security control engine, first user information associated with the first client device; determining, by the security control engine, second user information associated with the second client device; and granting, by the security control engine, access to the domain controller to the first client device based on the first user information correlating to the second user information.

Example 11 is the method of any previous or subsequent Example, wherein identifying, by the security control engine, the subset of client devices of the plurality of client devices as authorized for domain controller access further comprises: determining, by the security control engine, outgoing network connections for the subset of client devices from the historical data of the respective client devices; identifying, by the security control engine, one or more outgoing network connections involving a remote access protocol to the one or more domain controllers; and classifying, by the security control engine, the subset of client devices as authorized for domain controller access based on the one or more domain controller connections.

Example 12 is the method of any previous or subsequent Example, wherein blocking, by the security control engine, the remaining subset of client devices of the plurality of client devices from remotely accessing the one or more network devices corresponding to the one or more domain controllers based on the historical data of the respective client devices further comprises: generating, by the security control engine, an access policy that restricts the subset of client devices from establishing a connection using a remote access protocol with the one or more domain controllers; and applying, by the security control engine, the access policy to the subset of client devices.

Example 13 is the method of any previous or subsequent Example, wherein the historical data of the plurality of client devices is retrieved at a first time for a predefined time period, and the method further comprises: iteratively retrieving, by the security control engine, the historical data of the plurality of client devices at a subsequent time for the predefined time period; updating, by the security control engine, the subset of client devices that are authorized for the domain controller access using the historical data retrieved at each subsequent time; and updating, by the security control engine, the remaining subset of client devices that are blocked from remotely accessing the one or more network devices corresponding to the one or more domain controllers based on the historical data retrieved at each subsequent time.

Example 14 is the method of any previous or subsequent Example, wherein the method further comprises: detecting, by the security control engine, a connection attempt to the one or more domain controllers by a first client device within the remaining subset of client devices; generating, by the security control engine, a notification that the first client device is blocked from remotely accessing the one or more domain controllers; and providing, by the security control engine, the notification to a security system.

Example 15 is a computer readable storage media comprising processor-executable instructions configured to cause a processor to: determine, by a security control engine, a first client device from a plurality of client devices for evaluation of domain controller access; determine, by the security control engine, first historical data associated with the first client device, wherein the first historical data comprises outgoing network connections for the first client device; identify, by the security control engine, one or more network devices within a network as corresponding to one or more domain controllers; classify, by the security control engine, the first client device into an authorized group for remotely accessing a first domain controller based on the first historical data, wherein the one or more domain controllers comprise the first domain controller; and grant, by a security control engine, an ability to remotely access the first domain controller for the first client device based on the classification of the first client device into the authorized group.

Example 16 is the computer readable storage media of any previous or subsequent Example, wherein the processor-executable instructions to classify, by the security control engine, the first client device into the authorized group for remotely accessing the first domain controller based on the first historical data cause the processor to further execute processor-executable instructions stored in the computer readable storage media to: determine, by the security control engine, that the outgoing network connections for the first client device correspond to a first network region; determine, by the security control engine, that the first domain controller is in the first network region; and classify, by the security control engine, the first client device into the authorized group for remotely accessing the first domain controller based on the first domain controller being in the first network region.

Example 17 is the computer readable storage media of any previous or subsequent Example, wherein the processor-executable instructions to classify, by the security control engine, the first client device into the authorized group for remotely accessing the first domain controller based on the first historical data cause the processor to further execute processor-executable instructions stored in the computer readable storage media to: determine, by the security control engine, a plurality of IP addresses for the one or more network devices corresponding to the one or more domain controllers; determine, by the security control engine, outgoing network connections for the first client device from the first historical data; determine, by the security control engine, a first IP address from the outgoing network connections of the first client device; and determine, by the security control engine, that the first IP address matches an IP address of a first device corresponding to the first domain controller, wherein the plurality of IP addresses comprises the IP address of the first device.

Example 18 is the computer readable storage media of any previous or subsequent Example, wherein the first historical data comprises first user data associated with the first client device; and wherein the processor-executable instructions to classify, by the security control engine, the first client device into the authorized group for remotely accessing the first domain controller based on the first historical data cause the processor to further execute processor-executable instructions stored in the computer readable storage media to: determine, by the security control engine, second user data associated with a second client device classified in the authorized group; and classify, by the security control engine, the first client device into the authorized group based on the first user data correlating to the second user data.

Example 19 is the computer readable storage media of any previous or subsequent Example, wherein: classification of the first client device into the authorized group for remotely accessing the first domain controller is performed at a first time; and the processor-executable instructions cause the processor to further execute processor-executable instructions stored in the computer readable storage media to: determine, by the security control engine, the first historical data associated with the first client device at a second time, wherein the first historical data at the second time encompasses a different time period of outgoing network connections for the first client device than the first historical data at the first time; and remove, by the security control engine, the first client device from the authorized group for remotely accessing the first domain controller based on the first historical data at the second time.

Example 20 is the computer readable storage media of any previous or subsequent Example, wherein the processor-executable instructions cause the processor to further execute processor-executable instructions stored in the computer readable storage media to: determine, by the security control engine, second historical data associated with a second client device of the plurality of client devices, wherein the second historical data comprises outgoing network connections for the second client device; classify, by the security control engine, the second client device into an unauthorized group for remotely accessing the first domain controller based on the second historical data; and apply, by the security control engine, an access policy to the second client device that blocks remote access to the first domain controller based on the classification of the second client device in the unauthorized group.

What is claimed is:

1. A computing apparatus comprising:
a computer-readable storage media;
a security control engine comprising processor-executable instructions stored on the computer-readable storage media; and
a processor coupled to the computer-readable storage media and configured to execute the processor-executable instructions, wherein the processor-executable instructions, when executed by the processor, direct the computing apparatus, to at least:
determine a plurality of client devices within a network;
determine historical data for the plurality of client devices, wherein the historical data comprises outgoing network connections for the plurality of client devices within the network;
classify a subset of client devices of the plurality of client devices into an unauthorized group for remotely accessing at least one domain controller using the historical data of the respective client devices; and
apply an access policy to the subset of client devices based on the subset of client devices being classified in the unauthorized group, wherein the access policy blocks remote access to the at least one domain controller.

2. The computing apparatus of claim 1, wherein the processor-executable instructions to classify the subset of client devices into the unauthorized group for remotely accessing the domain controller using the historical data of the respective client devices, when executed by the processor, further direct the computing apparatus to:
identify a plurality of IP addresses within the outgoing network connections for the subset of client devices during an evaluation interval;
determine that none of the plurality of IP addresses correspond to an IP address of a domain controller within the evaluation interval; and
classify the subset of client devices into the unauthorized group based on none of the outgoing network connections corresponding to a domain controller.

3. The computing apparatus of claim 1, wherein:
the processor-executable instructions, when executed by the processor, further direct the computing apparatus to:
identify IP addresses of the one or more network devices identified as the one or more domain controllers; and
the processor-executable instructions to classify the subset of client devices into the unauthorized group for remotely accessing the at least one domain controller using the historical data of the respective client devices, when executed by the processor, further direct the computing apparatus to:
identify a second subset of client devices comprising outgoing network connections to the IP addresses of the one or more network devices identified as the one or more domain controllers;
classify the second subset of client devices of the plurality of client devices into an authorized group for remotely accessing the at least one domain controller; and
classify the subset of client devices into the unauthorized group based on the second subset of client devices being classified into the authorized group.

4. The computing apparatus of claim 1, wherein the processor-executable instructions, when executed by the processor, further direct the computing apparatus to:
receive an indication that classification of a first client device into the unauthorized group is incorrect;
modify the access policy to the subset of client devices based on the indication; and
reclassify the first client device into an authorized group based on the modification to the access policy, wherein the authorized group is granted access to the at least one domain controller.

5. The computing apparatus of claim 1, wherein:
classification of the subset of client devices into the unauthorized group for remotely accessing the at least one domain controller is determined based on the historical data of the respective client devices during a first time period; and
the processor-executable instructions, when executed by the processor, further direct the computing apparatus to:
determine the historical data for the subset of client devices during a second time period, wherein the second time period is different than the first time period;
determine that the outgoing network connections for a first client device of the subset of client devices during the second time period comprise a domain controller connection to at least one domain controller; and
remove the first client device from the unauthorized group for remotely accessing the at least one domain controller.

6. The computing apparatus of claim 1, wherein the processor-executable instructions, when executed by the processor, further direct the computing apparatus to:
detect, by the security control engine, a connection attempt to the at least one domain controller by a first client device within the subset of client devices;
block, by the security control engine, access of the first client device to the at least one domain controller based on the access policy; and
generate, by the security control engine, a notification that the first client device is blocked from remotely accessing the at least one domain controller.

7. A method comprising:
determining, by a security control engine, a plurality of client devices for evaluation of domain controller access;
identifying, by the security control engine, one or more network devices within a network as one or more domain controllers;
retrieving, by the security control engine, historical data of the plurality of client devices;
identifying, by the security control engine, a subset of client devices of the plurality of client devices as authorized for domain controller access using the historical data of the respective client devices; and
blocking, by the security control engine, a remaining subset of client devices of the plurality of client devices from remotely accessing the one or more network devices corresponding to the one or more domain controllers based on the historical data of the respective client devices.

8. The method of claim 7, wherein identifying, by the security control engine, the subset of client devices of the plurality of client devices as authorized for domain controller access further comprises:
determining, by the security control engine, outgoing network connections for the subset of client devices from the historical data of the respective client devices;
identifying, by the security control engine, one or more domain controller connections in the outgoing network connections for the subset of client devices; and
classifying, by the security control engine, the subset of client devices as authorized for domain controller access based on the one or more domain controller connections.

9. The method of claim 7, wherein identifying, by the security control engine, the subset of client devices of the plurality of client devices as authorized for domain controller access further comprises:
identifying, by the security control engine, IP addresses of the one or more network devices corresponding to the one or more domain controllers within an evaluation interval;
identifying, by the security control engine, a subset of IP addresses from the historical data associated with the subset of client devices that match the IP addresses of the one or more network devices corresponding to the one or more domain controllers within the evaluation interval; and
classifying, by the security control engine, the subset of client devices as authorized for domain controller access based on the subset of IP addresses matching the IP addresses of the one or more network devices corresponding to the one or more domain controllers.

10. The method of claim 7, wherein the subset of client devices comprises a first client device; and wherein identifying, by the security control engine, the subset of client devices of the plurality of client devices as authorized for domain controller access further comprises:
identifying, by the security control engine, a second client device having domain controller access;
determining, by the security control engine, first user information associated with the first client device;
determining, by the security control engine, second user information associated with the second client device; and
granting, by the security control engine, access to the domain controller to the first client device based on the first user information correlating to the second user information.

11. The method of claim 7, wherein identifying, by the security control engine, the subset of client devices of the plurality of client devices as authorized for domain controller access further comprises:
determining, by the security control engine, outgoing network connections for the subset of client devices from the historical data of the respective client devices;
identifying, by the security control engine, one or more outgoing network connections involving a remote access protocol to the one or more domain controllers; and
classifying, by the security control engine, the subset of client devices as authorized for domain controller access based on the one or more domain controller connections.

12. The method of claim 7, wherein blocking, by the security control engine, the remaining subset of client devices of the plurality of client devices from remotely accessing the one or more network devices corresponding to the one or more domain controllers based on the historical data of the respective client devices further comprises:
generating, by the security control engine, an access policy that restricts the subset of client devices from establishing a connection using a remote access protocol with the one or more domain controllers; and
applying, by the security control engine, the access policy to the subset of client devices.

13. The method of claim 7, wherein the historical data of the plurality of client devices is retrieved at a first time for a predefined time period, and the method further comprises:
iteratively retrieving, by the security control engine, the historical data of the plurality of client devices at a subsequent time for the predefined time period;
updating, by the security control engine, the subset of client devices that are authorized for the domain controller access using the historical data retrieved at each subsequent time; and
updating, by the security control engine, the remaining subset of client devices that are blocked from remotely accessing the one or more network devices corresponding to the one or more domain controllers based on the historical data retrieved at each subsequent time.

14. The method of claim 7, wherein the method further comprises:
detecting, by the security control engine, a connection attempt to the one or more domain controllers by a first client device within the remaining subset of client devices;
generating, by the security control engine, a notification that the first client device is blocked from remotely accessing the one or more domain controllers; and
providing, by the security control engine, the notification to a security system.

15. A computer readable storage media comprising processor-executable instructions configured to cause a processor to:
determine, by a security control engine, a first client device from a plurality of client devices for evaluation of domain controller access;
determine, by the security control engine, first historical data associated with the first client device, wherein the first historical data comprises outgoing network connections for the first client device;
identify, by the security control engine, one or more network devices within a network as corresponding to one or more domain controllers;
classify, by the security control engine, the first client device into an authorized group for remotely accessing a first domain controller based on the first historical data, wherein the one or more domain controllers comprise the first domain controller; and
grant, by a security control engine, an ability to remotely access the first domain controller for the first client device based on the classification of the first client device into the authorized group.

16. The computer readable storage media of claim 15, wherein the processor-executable instructions to classify, by the security control engine, the first client device into the authorized group for remotely accessing the first domain controller based on the first historical data cause the processor to further execute processor-executable instructions stored in the computer readable storage media to:
determine, by the security control engine, that the outgoing network connections for the first client device correspond to a first network region;
determine, by the security control engine, that the first domain controller is in the first network region; and
classify, by the security control engine, the first client device into the authorized group for remotely accessing the first domain controller based on the first domain controller being in the first network region.

17. The computer readable storage media of claim 15, wherein the processor-executable instructions to classify, by the security control engine, the first client device into the authorized group for remotely accessing the first domain controller based on the first historical data cause the processor to further execute processor-executable instructions stored in the computer readable storage media to:
determine, by the security control engine, a plurality of IP addresses for the one or more network devices corresponding to the one or more domain controllers;
determine, by the security control engine, outgoing network connections for the first client device from the first historical data;
determine, by the security control engine, a first IP address from the outgoing network connections of the first client device; and
determine, by the security control engine, that the first IP address matches an IP address of a first device corresponding to the first domain controller, wherein the plurality of IP addresses comprises the IP address of the first device.

18. The computer readable storage media of claim 15, wherein the first historical data comprises first user data associated with the first client device; and wherein the processor-executable instructions to classify, by the security control engine, the first client device into the authorized group for remotely accessing the first domain controller based on the first historical data cause the processor to further execute processor-executable instructions stored in the computer readable storage media to:
determine, by the security control engine, second user data associated with a second client device classified in the authorized group; and
classify, by the security control engine, the first client device into the authorized group based on the first user data correlating to the second user data.

19. The computer readable storage media of claim 15, wherein:
classification of the first client device into the authorized group for remotely accessing the first domain controller is performed at a first time; and
the processor-executable instructions cause the processor to further execute processor-executable instructions stored in the computer readable storage media to:
determine, by the security control engine, the first historical data associated with the first client device at a second time, wherein the first historical data at the second time encompasses a different time period of outgoing network connections for the first client device than the first historical data at the first time; and
remove, by the security control engine, the first client device from the authorized group for remotely accessing the first domain controller based on the first historical data at the second time.

20. The computer readable storage media of claim 15, wherein the processor-executable instructions cause the processor to further execute processor-executable instructions stored in the computer readable storage media to:
determine, by the security control engine, second historical data associated with a second client device of the plurality of client devices, wherein the second historical data comprises outgoing network connections for the second client device;
classify, by the security control engine, the second client device into an unauthorized group for remotely accessing the first domain controller based on the second historical data; and
apply, by the security control engine, an access policy to the second client device that blocks remote access to the first domain controller based on the classification of the second client device in the unauthorized group.
